(19) United States
(12) Patent Application Publication
(10) Pub. No.: US 2026/0002563 A1
(43) Pub. Date: Jan. 1, 2026

(54) BALL JOINT ASSEMBLY

(71) Applicant: Niwot Corporation d/b/a Specialty Products Company, Longmont, CO (US)

(72) Inventor: Harrison M. Luginbill-Ruder, Broomfield, CO (US)

(21) Appl. No.: 19/249,551

(22) Filed: Jun. 25, 2025

Related U.S. Application Data
(60) Provisional application No. 63/665,586, filed on Jun. 28, 2024.

(51) Int. Cl. F16C 11/06

(52) U.S. Cl. CPC F16C 11/0614; F16C 11/0604; F16C 11/068

(57) ABSTRACT

A ball joint assembly including a housing defining a chamber, a race positioned in the chamber and defining an annular wall including a seat recess, a movable shaft including a ball and at least one stud extending from the ball, the ball being received in the seat recess and the at least one stud extending out of the chamber, and a retainer positioned at least partially in the chamber and engaging a surface of the race, and wherein at least one protrusion on one of the race or retainer engages a corresponding at least one key recess on the other of the race or retainer to restrict relative movement between the race and the retainer.

### CROSS REFERENCE TO RELATED APPLICATIONS

This application claims the benefit of priority pursuant to 35 U.S.C. § 119(e) of U.S. Provisional Patent Application No. 63/665,586, filed Jun. 28, 2024, entitled “BALL JOINT ASSEMBLY,” which is hereby incorporated by reference herein in its entirety.

### FIELD

The described embodiments relate generally to a joint assembly. More particularly, the present embodiments relate to a ball joint assembly.

### BACKGROUND

Ball joints may be joints allowing freedom of movement rotationally while constraining movement a radial or axial direction. Ball joints may be used to connect two or more features together while allowing relative movement between those features. For example, ball joints are found in many locations on automotive suspension designs.

The internal ball-and-socket bearing components are the elements of the joint that transfer loads and allow the rotational movement of the suspension under these loads. As the suspension moves and the ball joint rotates, the ball rotates within the socket or race. Because of severe and constantly changing nature of the loading conditions, tolerances or unintended ranges of motions can cause noise, vibration, or harshness. Any movement beyond the inner ball's rotation in the race, e.g. axial or radial movement, is referred to as lash. When lash develops in a joint, the joint often begins to deteriorate rapidly as the increased movement increases the progression of wear.

Another common failure mode of ball joint assemblies is corrosion and wear from the ingress of contaminants. Because of the location these ball joints may be used on a vehicle, they are often subject to harsh environmental conditions, as well as to bombardment with solid and liquid road debris. Corrosion and debris ingress increase wear within the bearing system, which ultimately leads to the development of lash or limited movement of the joint.

Accordingly, a ball joint having improved resistance to wear or corrosion is needed.

### SUMMARY

Embodiments of the present invention are directed to a ball joint assembly.

In one example, the ball joint assembly includes a housing defining a chamber and a race positioned in the chamber and defining an annular wall including a seat recess. The ball joint assembly includes a movable shaft including a ball and at least one stud extending from the ball, the ball being received in the seat recess and the at least one stud extending out of the chamber, and a retainer positioned at least partially in the chamber and engaging a surface of the race. The at least one protrusion of one of the race or retainer engages a corresponding at least one key recess on the other of the race or retainer to restrict relative movement between the race and the retainer.

In some examples, the at least one protrusion extends from the retainer.

In some examples, the at least one key recess is defined at least in part by a top surface of the race.

In some examples, the annular wall defines the at least one key recess extending from the seat recess to an exterior of the race.

In some examples, the at least one key recess is defined at least in part by an exterior of the annular wall of the race.

In some examples, the race defines the at least one key recess and a second recess, and the retainer defines the at least one protrusion and a second protrusion.

In some examples, the at least one key recess and the second recess are annularly spaced about the seat recess, the at least one protrusion and the second protrusion are correspondingly and annularly spaced about an axially interior surface of the retainer.

In some examples, the at least one protrusion extends from the race, and the at least one key recess is defined at least in part by the retainer.

In some examples, an interior of the retainer is spaced from the stud defining an annular volume.

In some examples, the annular volume retains a lubricating fluid.

In some examples, the ball joint assembly further includes a retainer assembly including the retainer defining a bond surface, and a flexible seal overmolded to the retainer along the bond surface and coupled to the at least one stud. The retainer and flexible seal define, in part, the annular volume.

In some examples, the flexible seal limits ingress or egress of contaminants to the grease reservoir.

In some examples, the retainer is positioned to limit or prevent movement of the race relative to the housing.

In some examples, the ball joint assembly further includes a second retainer positioned at least partially in the chamber and opposite the ball from the retainer, and the second retainer engages a second surface of the race.

In some examples, the housing defines a swaged portion at an opening to the chamber, and the swaged portion limits axial movement of at least one of the race, movable shaft, or retainer relative to the housing.

In some examples, the movable shaft includes a second stud extending from the chamber opposite the at least one stud.

In one example, another example of a ball joint assembly is disclosed. The ball joint assembly includes a housing defining an opening or a chamber, and a race positioned in the opening and defining an annular wall including a seat recess. The ball joint assembly includes a movable shaft including a ball and a first stud extending from the ball, the ball being received in the seat recess and the at least one stud extending out of the chamber, and a retainer assembly. The retainer assembly includes a retainer defining a bond surface and positioned at least partially in the chamber, and a flexible seal overmolded to the retainer along the bond surface and coupled to the at least one stud.

In some examples, the flexible seal at least partially defines a grease reservoir annularly about at least the first stud.

In some examples, the flexible seal limits ingress or egress of contaminants to the grease reservoir.

In some examples, the flexible seal defines an annular projection positioned along the bond surface.

In some examples, the flexible seal includes a first annular projection and a second annular projection, and the first annular projection and the second annular projection are axially spaced.

In some examples, the flexible seal defines a first annular projection and a second annular projection, and the first annular projection and the second annular projection are radially spaced.

In some examples, the retainer defines an annular recess to increase a surface area of the bond surface.

In some examples, the flexible seal is coupled to the movable shaft by an annular feature to define an upper connection.

In some examples, the movable shaft defines a trough positioned between a first flange and a second flange, the flexible seal is coupled to the movable shaft and positioned at the trough.

In some examples, an interior surface of the seal defines at least one recess, the interior surface is engaged with the movable shaft, and the at least one recess retains or receives grease between the seal and the movable shaft.

In some examples, at least one protrusion on one of the race or retainer engages a corresponding at least one key recess on the other of the race or retainer to restrict relative movement between the race and the retainer.

In some examples, the at least one protrusion extends from a bottom of the retainer, the at least one key recess is defined at least in part by a top of the race, and the bottom of the retainer contacts the top of the race.

A number of feature refinements and additional features are applicable in the first aspect and contemplated in light of the present disclosure. These feature refinements and additional features may be used individually or in any combination. As such, each of the following features that will be discussed may be, but are not required to be, used with any other feature combination of the first aspect. In addition to the exemplary aspects and embodiments described above, further aspects and embodiments will become apparent by reference to the drawings and by study of the following description.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A depicts a perspective view of an example ball joint assembly;

FIG. 1B depicts a cross-sectional view of the example ball joint assembly of FIG. 1A;

FIG. 2 depicts an exploded view of the example ball joint assembly of FIG. 1A;

FIG. 3 depicts a cross-sectional view of an example housing of the example ball joint assembly;

FIG. 4 depicts a perspective view of a movable shaft of the example ball joint assembly;

FIG. 5 depicts a top perspective view of an example race of the example ball joint assembly;

FIG. 6A depicts a bottom perspective view of an example retainer assembly of the example ball joint assembly;

FIG. 6B depicts a cross-sectional view of the example retainer assembly of FIG. 6A;

FIG. 7A depicts a perspective view of the example retainer assembly and the example race aligned for engagement;

FIG. 7B depicts a perspective view of the example retainer assembly and the example race in engagement;

FIG. 8 depicts a cross-sectional view of the example ball joint assembly in an example rotated configuration;

FIG. 9 depicts a cross-sectional view of another example of a retainer assembly;

FIG. 10A depicts a cross-sectional view of an additional example of a ball joint assembly;

FIG. 10B depicts a cross-sectional view of an additional example of a ball joint assembly;

FIG. 11A depicts a cross-sectional view of an example of a ball joint assembly; and

FIG. 11B depicts the example ball joint assembly of FIG. 11A in a rotated configuration.

### DETAILED DESCRIPTION

The description that follows includes sample systems, methods, and apparatuses that embody various elements of the present disclosure. However, it should be understood that the described disclosure may be practiced in a variety of forms in addition to those described herein.

The following disclosure relates to a ball joint assembly. Ball joint assemblies may be used to connect two or more features together while allowing relative movement between the features. For example, a ball joint assembly may be used in automotive applications such as suspension linkages extending between the wheel and the automobile body.

The ball joint assembly includes a housing defining a chamber, a race, and a movable shaft. The movable shaft may include a ball portion positioned within a seat recess of the race. The race may be a smooth material such as plastic and define a bearing surface allowing rotation of the movable shaft. A retainer assembly may secure the race and movable shaft within the housing.

The retainer assembly may include a retainer in contact with the race and a flexible seal. The flexible seal may be overmolded with a portion of the retainer. The flexible seal may extend between the retainer and a portion of the movable shaft to define and seal an interior volume.

In some examples, one or both of the retainer or the race may define at least one protrusion positionable within a corresponding key recess of the other of the retainer and the race. In one example, the retainer defines at least one protrusion extending from a surface to seat within a key recess, defined by a portion of the race, to define a keyed relationship. The housing, race, and retainer assembly may constrain axial or radial movement of the movable shaft such that the movable shaft may support a load and rotate radially or axially relative to the housing.

In some examples, the housing may define an annular lip, which in one example may be swaged, extending about an opening of the chamber and in contact with the retainer. For example, the retainer assembly may be positioned in the chamber and an end of the housing may at least partially form a lip in contact with the retainer assembly to secure the retainer assembly within the chamber. The lip may be formed by, for example, folding, bending, rolling, or caulking the material. The lip may be in contact with the retainer assembly and generate friction between the retainer and housing, resisting potential rotation of the retainer assembly relative to the housing. In some examples, the retainer may be a durable material, such as a metal, and resist wear with the chamber.

One of the common failure modes that creates lash in ball joints occurs when the race rotates within housing chamber during operation. When the race moves relative to the housing, the race against housing acts as a poor bearing surface and may wear down. It also reduces the effectiveness of the intended bearing surface, e.g. the ball-and-socket, which may no longer act as the primary bearing or rotational surface under these conditions. Rotation of the race may result in wear on the exterior surfaces of the race, resulting in less contact with the housing or further movement of the race relative to the housing. These wear patterns result in accelerated wear and, ultimately, lash is developed between the ball-and-socket bearing and one or more of the race, retainer assembly, or housing.

To limit movement of the race relative to the housing, and the development of lash or space for unintended movement of the movable shaft, the race and retainer assembly may be positioned in a keyed engagement within the chamber. For example, a keyed engagement may be defined between at least one protrusion on one of the race or retainer that engages or is received by a corresponding at least one key recess defined by the other of the race or retainer. The keyed engagement between the protrusion and recess of the retainer assembly and the race may limit, or prevent, movement of the race relative to the retainer. The retainer may be more durable than the race and may resist wear resulting from the rotational torque for a longer duration before lash develops between the race and the housing, (e.g. before the race moves relative to the housing), providing an increased life span for a ball joint assembly. Instead, rotational torque on the race is transmitted to the retainer by the keyed relationship. In some examples, the swage lip may provide a substantial or sufficient force of friction, between the retainer and the housing to limit movement of either the retainer assembly or the race relative to the housing.

Another common failure mode of ball joint assemblies is corrosion and wear from the ingress of contaminants. For example, where ball joints may be located on a vehicle may be routinely bombarded with solid and liquid road debris. To limit corrosion, ball joint assemblies have included a boot feature to act as a barrier. However, the existing boots have been separate features that are attached to a ball joint during assembly. The separate and larger boots may have a weak (e.g. insufficient) connection with the ball joint at either and buckle or flex, allowing in contaminants at either end. To accommodate the assembly of separate boots, joint assemblies often must be larger in size in order to provide sufficient clearance to mount the boot and affix retainment parts to the boot to limit separation from the rest of the joint assembly. The retainment parts, such as, wires, clips, and retaining rings, can puncture or pinch a boot, creating a potential leak path, and may be difficult to install. Additional care must be taken when assembling the boot and adds cost and complexity to the ball joint assembly.

The flexible seal described herein may reduce or limit the entry of contaminants to an internal volume of the ball joint. A retainer may include the flexible seal overmolded to the retainer along a bond surface to provide a robust static seal with the retainer. The flexible seal may maintain continuous contact with the retainer along the bond surface and reduce or eliminate ingress of contaminants. In comparison to a boot, or separately attached features, the at least one permanently sealed end removes approximately 50% of ingress points. Furthermore, the unitary structure of the retainer assembly (e.g. the retainer and bonded flexible seal) can reduce overall size of the ball joint. For example, space within the joint for a boot retainment part and corresponding sealing feature, such as a retaining wire may no longer be needed. As a result, the retainer assembly requires significantly less space within the joint to accomplish equivalent or improved attachment and sealing means.

The improved connection between a seal and the retainer may additionally or alternatively accommodate an increased internal volume of the ball joint assembly, or grease reservoir. The grease reservoir may be defined in part by the flexible seal and retainer assembly and extend annularly about the movable shaft. The grease in the reservoir may act as a barrier or trap for contaminants and prevent or reduce corrosion, or to lubricate the surfaces of the ball or race and reduce wear.

Reference will now be made to the accompanying drawings, which assist in illustrating various features of the present disclosure. The following description is presented for purposes of illustration and description. Furthermore, the description is not intended to limit the inventive aspects to the forms disclosed herein. Consequently, variations and modifications commensurate with the following teachings, and skill and knowledge of the relevant art, are within the scope of the present inventive aspects.

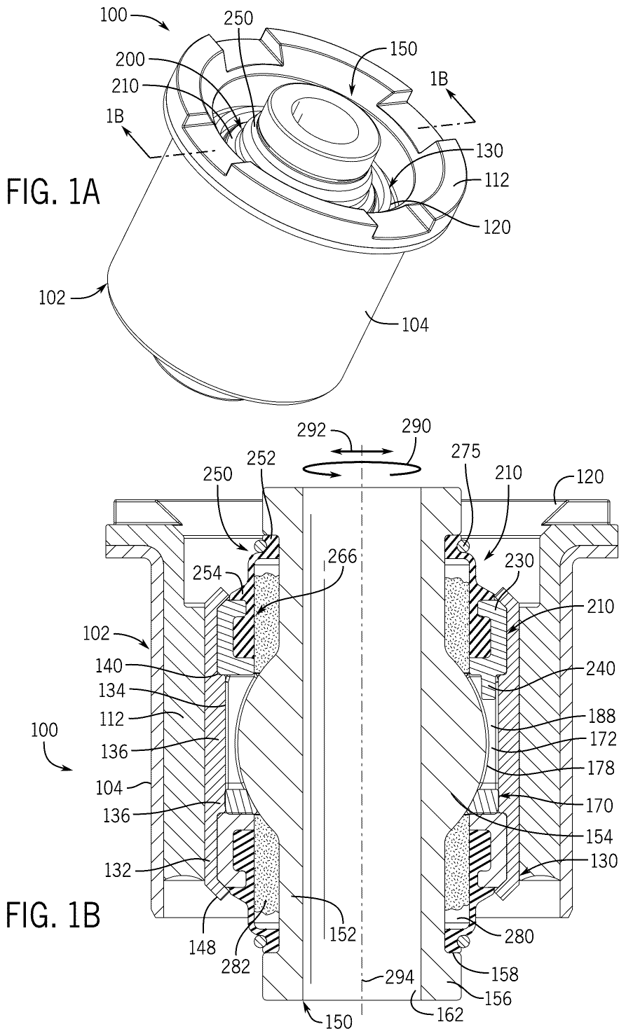

Turning to the drawings, FIGS. 1A and 1B depicts a perspective view of an example ball joint assembly 100. The ball joint assembly 100 may be connected between two or more separate components and enable relative movement between the two or more components. In one example, the ball joint assembly 100 may be used to connect components of an automotive vehicle, such as linkages of a suspension system.

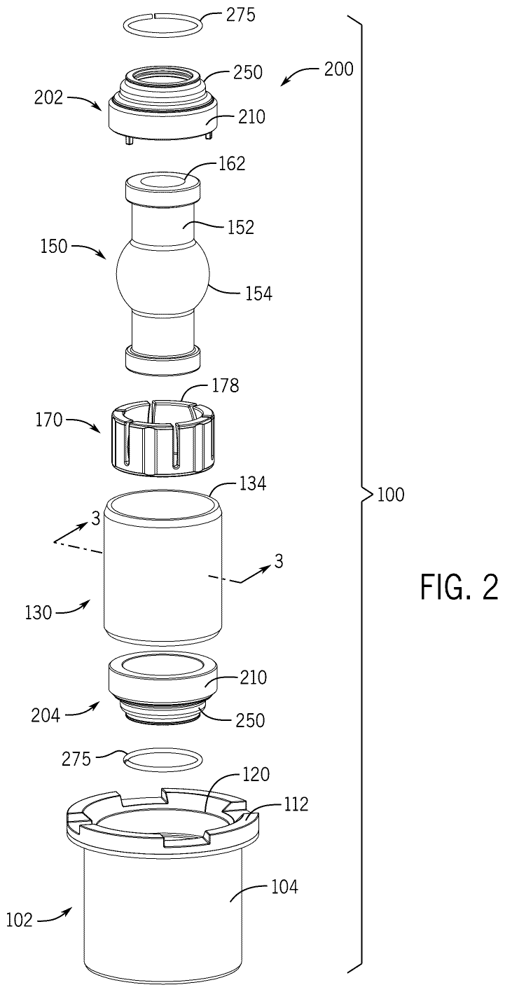

With continued reference to FIG. 1A-1B and with reference to FIG. 2, the ball joint assembly 100 may optionally include an outer casing 102. The outer casing 102 may include an outer shell 104 and a bushing 112. The outer shell 104 may be a cylindrical feature. The outer shell 104 may be a rigid or semi-rigid material. For example, the outer shell 104 may be metallic or a polymer. The bushing 112 may be a corresponding cylindrical feature positioned within or bonded to the outer shell 104. The bushing 112 may be a rigid or semi-rigid material. The material of the bushing 112 may absorb or disperse forces upon the ball joint assembly 100. For example, the bushing 112 may be a rubber or polymer material. The outer casing 102, or the outer shell 104 and the bushing 112, may define a casing aperture 120 extending axially there through. The aperture 120 may be circular. In some examples, the casing 102 may have a height between 3.5 and 7 cm. In one example, the outer casing 102 has a height of approximately 5 cm. The outer casing 102 aperture 120 may have an interior diameter between 3.5 and 6 cm. In one example, the outer casing 102 aperture 120 may be approximately 4.25 cm.

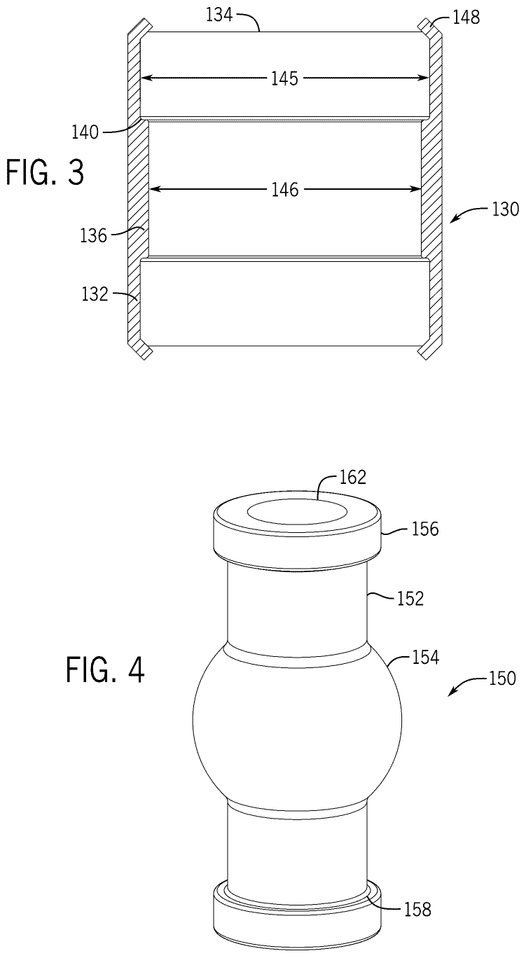

The ball joint assembly 100 includes a housing 130. FIG. 3 depicts a cross section of the housing 130. The housing 130 may be cylindrical. The body of the housing 130 may define housing walls 132. The housing 130, or walls 132, define a chamber 134. In some examples, the chamber 134 may be an aperture defined through the housing 130. For example, the chamber 134 may be circular and defined axially through the housing 130. The housing 130 may define an interior flange 136. The interior flange 136 may extend from the interior of the walls 132. The flange 136 may extend annularly about the chamber 134 along the wall. The housing 130 may define a shelf feature 140 extending between the walls 132 and the flange 136. The shelf 140 may be a laterally, or radially inward, extending portion. In some examples, the housing 130 may define an upper and lower shelf 140, such as at opposing ends of the flange 136.

The chamber 134 of the housing 130 may have a varying diameter. For example, the chamber 134 may have a first diameter 145 over a first portion, and a second diameter 146 over a second portion. The first portion may be defined between an end of the wall 132 and a shelf 140. The second portion may be defined along the interior flange 136, or between shelf features 140. The first diameter 145 may be larger than the second diameter 146. In some examples, the first diameter 145 may be between 3 and 4 cm, and in one example approximately 3.5 cm. In some examples, the second diameter 146 may be between 0.1 and 0.5 cm less than the first diameter, an in one example approximately 0.2 cm. In some examples, the housing 130 may have a height between approximately 2 and 5 cm. In one example, the housing 130 has a height of approximately 3-3.5 cm.

In some examples, the housing 130 may define an inward extending lip 148 about the chamber 134. The lip 148 may be a portion of the wall 132 extending at least partially inward. In some examples, the lip 148 may be formed by bending, folding, rolling, caulking an end of the wall 132. For example, the lip 148 may be a swaged or otherwise deformed portion of the wall 132. In some examples, the lip 148 may define, at least in part, a seal of the chamber 134. The lip 148 may be formed before, during, or after assembly of the ball joint 100, as discussed herein.

With reference to FIG. 4, the ball joint assembly 100 may include a movable shaft 150. The movable shaft 150 includes at least one stud 152 extending from a ball portion 154. The stud 152 may be an at least partially elongated cylindrical feature. The ball portion 154 may be at least partially spherical member or ball. In some examples, two studs 152 may extend from opposing sides of the ball portion 154. Each of the two studs 152 may extend along the same axis. In some examples including two studs 152, the shaft 150 may have a length between 4 and 8 cm. In one example, the movable shaft 150 may have a length of approximately between 6 and 7 cm.

The stud 152 may include a flange 156 at an end or portion spaced from the ball portion 154. In one example, the stud 152 defines two or more flanges between the ball portion 154 and an end of the stud 152. In examples of the shaft 150 including two studs 152, the flanges can be defined between either or both ends and the ball portion 154. The shaft flange 156 extends radially outward from the stud 152. The flange 156 can extend orthogonally outward or at an angle (e.g. 30 degrees, 45 degrees, or the like relative to the stud 152). In some examples, the shaft flange 156 extends annularly about the stud 152. The movable shaft 150 may include a seat 158 defined by the stud 152. For example, the shaft seat 158 may be defined in or adjacent the flange 156. In one example, a surface of the flange 156 defines the seat 158. The seat 158 may extend annularly about a portion of the stud 152.

The movable shaft 150 may define one or more shaft apertures 162. The shaft apertures 162 may be defined by the studs 152 extending axially inward. In one example, the shaft aperture 162 is defined axially through the height or length of the movable shaft 150. In other examples, the studs 152 define the shaft apertures 162 through a portion of the height of the studs 152. The apertures 162 may be arranged to receive a feature of a separate component, such as a suspension linkage or fastener. The apertures 162 may be circular or elliptical. The apertures 162 may be threaded, smooth, tapered, or the like.

The movable shaft 150 may be rigid and durable material. For example, the movable shaft 150 may supporting a load at a variety of orientations. The ball 154 may be relatively smooth or have a low coefficient of friction. In some examples, the movable shaft 150 may be a metallic feature. The movable shaft 150 may be an alloy and/or include a plating or coating to resist or prevent corrosion of the movable shaft 150.

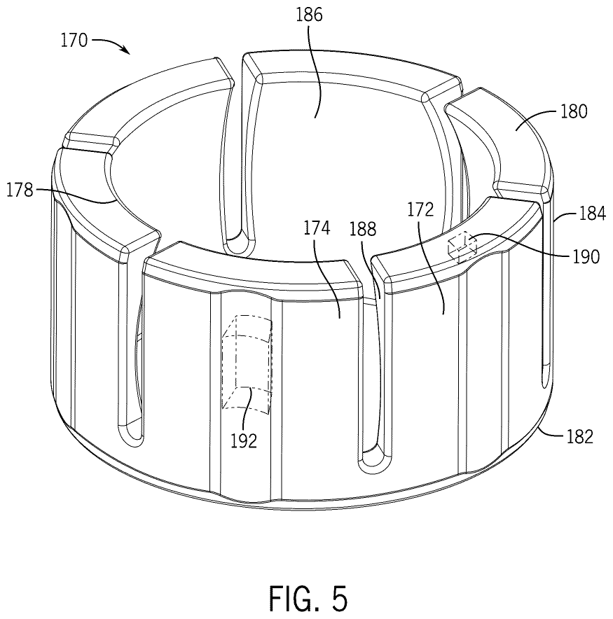

With reference to FIG. 5, the ball joint assembly 100 may include a race 170. The race 170 may have a disc or cylindrical shape. The race 170 may be defined by at least one or more annularly arranged walls 172 defining a body of the race 170. The race or the walls 172 may define a seat recess 178. The seat recess 178 may be an aperture extending through the race 170. In some examples, the seat recess 178 may be a depression extending only partially through the race 170. The race 170 includes a top 180, a bottom 182, an exterior 184, and an interior 186. The seat recess 178 may define the interior 186. In some examples, the race 170 may have a height between the bottom 182 and the top 180 between approximately 1 and 2.5 cm. In one example, the race 170 may be approximately 1.7 cm.

The seat recess 178 and/or the interior 186 of the annular walls 172 may be smooth and define a bearing surface having a low coefficient of friction. In some examples, the interior 186 of the annular walls 172 may have a concave curvature. In such an example, seat recess 178 may have an at least partially spherical volume.

The race 170 may define one or more key recesses 188. The annular walls 172 may be separated by or define the key recesses 188. The one or more key recesses 188 may be defined extending downward from the top 180, or upward from a bottom 182, of a wall 172. The key recess 188 may be defined through at least a partial thickness of the wall 172. In one example, the key recess 188 may extend from an interior 186, or the seat recess 178, to the exterior 184 of the race 170. In such an example, a first annular wall 172 may be at least partially spaced from a second annular wall 174 by the key recess 188. In such an example, the key recess 188 may permit deflection or movement of the first wall 172 and the second wall 174 relative to the other. In some examples, the race 170 may include two, three, four, five, six, seven, or more key recesses 188. In one example, the race 170 includes an even number of key recesses 188. In examples including two or more key recesses 188, the recesses 188 may be spaced annularly about the seat recess 178. In one example, the key recesses 188 may be spaced evenly about the seat recess 178 or race 170.

In some examples, a second key recess 190 may be additionally or alternatively defined in a top 180, or bottom 182, of the wall 174 and spaced from either or both the interior 186 or exterior 184 of the wall 172. In some examples, a third key recess 192 may be additionally or alternatively defined in an exterior 184 of the wall 172 and spaced from either or both the top 180 or bottom 182 of the wall 172. In some examples, the race 170 may define one or more axially extending protrusions in addition, or as an alternative, to the one or more key recesses 188.

The race 170 may be an integrally formed or unitary structure. The race 170 material may be a polymer or plastic. Polymer or plastic materials may have properties beneficial for forming a feature having a smooth or low friction surface. Polymer or plastic materials may be resiliently flexible materials.

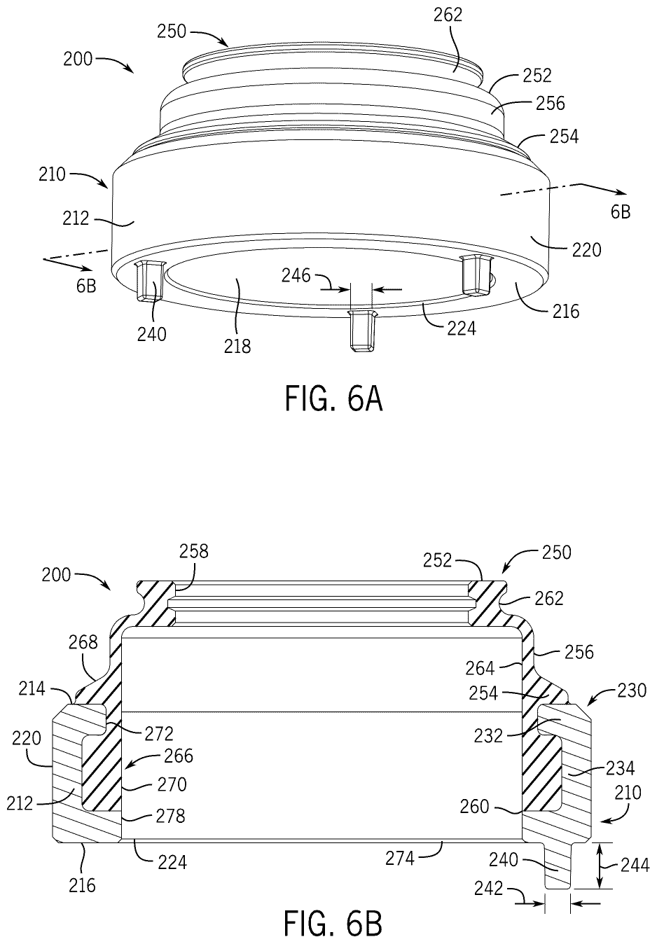

With reference to FIGS. 6A-6B, the ball joint assembly 100 may include a retainer assembly 200. The retainer assembly 200 can include a retainer 210 and a flexible seal 250. The flexible seal 250 may be overmolded or otherwise connected to the retainer 210 along a bond surface 230.

The retainer 210 may be a disc or cylindrically shaped feature. The retainer 210 may be defined in part by a ring 212, or annular wall, extending about and defining a retainer aperture 224. The retainer 210 may have a top 214 and a bottom 216, and an interior 218 and an exterior 220.

The retainer 210 may include or define a bond surface 230. In some examples, the bond surface 230 may be defined at least partially by the interior 218 and/or the top 214 of the retainer 210. For example, the bond surface 230 may be defined in part by a flange 232 extending radially inward from the ring 212. The flange 232 may be defined discontinuously or continuously along the ring 212. In some examples, the flange 232 may at least partially define the top 214, or extend from the top 214, of the ring 212. The bond surface 230 may define, at least in part, one or more bond recesses 234. The bond recesses 234 may defined by an interior 218 of the ring 212. The recess 234 may be defined axially between the flange 232 and another portion of the ring 212, such as the bottom 216, and radially inward from the interior 218. The bond surface 230 may be continuous, such as along the flange 232 and the recess 234. In some examples, one or more features of the bond surface 230 may be discontinuous or vary circumferentially along the retainer 210.

The retainer 210 may include or define one or more key protrusions 240 extending from the retainer 210. The key protrusions 240 may extend axially or radially from the ring 212. In some examples, the protrusions 240 may extend from a bottom 216, or extend to a location below the bottom 216, of the retainer 210. The protrusions 240 may be tangs, teeth, detents, or the like. The protrusions 240 may have a width 242, height 244, and depth 246. In some examples the protrusions may have a width 242, height 244, or depth 246 between approximately and including 1 and 4 mm. The protrusions 240 may have a square, rectangular, triangular, trapezoidal, elliptical, or various other cross sectional configurations. In some examples, the protrusions 240 may taper along the height 244. For example, a width 242 or depth 246 of the protrusion 240 at a distal end, may be different than a width 242 or depth 246 at the base of the protrusion 240. In one example, a depth 246 or width 242 decreases down the height.

The retainer 210 may be a durable or wear resistant feature. For example, the retainer 210 may be or include a metallic material. The retainer 210 may include a coating, plating, or be formed from an alloy resistant to corrosion. The retainer 210 may be an integrally formed feature, or include two or more separately connected features. For example, the retainer 210 may be formed in a mold, machined from a larger material, include one or more welded features, or the like.

The retainer assembly 200 includes a flexible seal 250. The flexible seal 250 may include an outer or upper annular feature 252 and an inner or lower annular feature 254 connected by an extension 256. The flexible seal 250 may be cylindrical or cup shaped.

The upper annular feature 252 may be a ring shaped portion of the flexible seal 250 defining a top aperture 258. The upper annular feature 252 may define a top or upper end of the flexible seal 250. The upper annular feature 252 may define a rim or recess 262 extending about an exterior of the upper annular feature 252. The upper annular feature 252 may have an increased thickness compared to surrounding or adjacent portions of the seal 250. The increased thickness of the upper annular feature 252 may increase a tension of the upper annular feature 252, or a resist or resiliently bias to an initial shape in response to stretching or deflection.

The lower annular feature 260 may define an axially lower or bottom portion of the seal 250. The lower annular feature 260 may be a ring shaped portion of the flexible seal 250 defining a bottom or lower aperture. The lower annular feature 260 may have an increased thickness compared to surrounding or adjacent portions of the seal 250. For example, the lower annular feature 260 may similarly have an increased tensile response to resist or resiliently bias to an initial shape in response to stretching or deflection.

The extension 256 may be a portion of the seal 250 extending between or connecting the upper annular feature 252 and the lower annular feature 260. The extension 256 may have a thickness similar to or thinner than the upper annular feature 252 or the lower annular feature 260. The extension 256 may be resiliently flexible or elastic. For example, the extension 256 may at least bend, twist, or elongate some distance or direction and return or bias to an initial dimension or configuration. In some examples, the extension 256 may be barrel shaped, domed, or the like. In such an example, the curvature of the extension 256 between the upper annular feature 252 or the lower annular feature 260 may provide material that may move before flexing to increase a range of motion of the joint assembly 100 before resiliently flexing. In some examples, the extension 256 may define one or more folds, such as a double fold having an S-shaped profile. In such an example, the folds may provide additional material to enable movement or flexing of the extension 256 before resiliently flexing or stretching.

The inner or lower aperture 260 and the outer or upper aperture 258 may together define a continuous aperture 264 through the flexible seal 250. The lower aperture 260 may be wider than the upper aperture 258. As a result, the extension 256 may extend radially outwardly and downwardly (e.g. inwardly) from the upper annular feature 252 to the lower annular feature 254.

The lower annular feature 260 may include bonding features 266. The bonding features 266 may include one or more annular projections, such as radially or axially, from the lower annular feature 260. In some examples, the bonding features 266 may define two or more annular projections. In one example, the bonding features 266 includes a first surface flange 268 spaced from a second surface flange 270. The bonding features 266 may form a securement recess or indent 272 therebetween. In some examples, the first surface flange 268 and the second surface flange 270 be axially spaced, for example the first surface flange 268 may be outwardly positioned from the second surface flange 270, or be spaced or extend radially outward. In other examples, the flanges 268, 270 may be radially spaced or extend axially. The first surface flange 268 may be positioned axially above the second surface flange 270.

The flexible seal 250 may include a material that is flexible or resiliently deformable. The material may be water proof or water resistant. In some examples, the flexible seal 250 may be a rubber or polymer. The flexible seal 250 may be a thermoplastic. For example, the flexible seal 250 may be neoprene. The flexible seal 250 may be formed by injection molding.

The flexible seal 250 may be bonded to the retainer 210 to define the retainer assembly 200. The flexible seal 250 may be overmolded to the retainer 210. For example, the flexible seal 250 may be injection molded with or to the retainer 210, at least in part. The flexible seal 250 may be formed with a retainer 210 defining a portion of a mold. In some examples, a portion of the flexible seal 250 may be formed separately with the retainer 210. For example, the bonding features 266 may be molded separately from an initially molded portion of the flexible seal 250 or otherwise later bonded to the bond surface 230 to connect the retainer 210 and the flexible seal 250. In such examples, the flexible seal 250 may be a thermoplastic heated and molded to the retainer 210 after forming, or connected to the retainer 210 by an adhesive forming a bond.

In at least one example, the bonding features 266, or the lower annular feature 254, may be formed by injection molding the material of the flexible seal 250 at the bond surface 230. The material of the seal 250 may flow or set at the features of the bond surface 230. In such an example, the bond surface 230 may at least partially define the bonding features 266. For example, the recess 234 may define or receive the second surface flange 270. The retainer flange 232 may define or be received in the securement recess 272. The first surface flange 270 may be defined by or received in part at by the top 214 of the ring 212, or the flange 232. The bonding features 266, and the lower annular feature 254, may be bonded continuously over at least a portion of the bond surface 230, or a top 214 of the ring 212. As a result, the retainer 210 and the flexible seal 250 may be connected along a continuous surface defining a seal.

In some examples, the bond surface 230 and the bonding feature 266 may define a mechanical interference to connect or secure the flexible seal 250 and the retainer 210 in addition to the bonding forces. A mechanical interference may be defined when at least one feature of the retainer 210 or seal 250 blocks or limits removal of a first feature of one by a second feature of the other. For example, the bottom 216 of the ring 212 and the flange 232 may cooperate to limit axial movement of the lower or second bonding flange 270, such as out of the recess 234, and therefore the seal 250. The ring 212 may additionally or alternatively limit outward radial movement of the bonding features 266 or seal 250 relative to the retainer 210. In some examples, the upper 268 and lower 270 bonding flanges may limit axial movement of the retainer flange 232, such as out of the indent 272.

By bonding the seal 250 to the retainer 210, a continuous seal may be defined that limits or prevents ingress at least one end of the seal 250. With the retainer 210 and the flexible seal 250 bonded, a continuous aperture 274 through the retainer assembly 200 may be defined. For example, the retainer aperture 224 defined by the retainer 210 may be axially aligned with the seal aperture 264 to define a retainer aperture 274 extending axially through the retainer assembly 200.

In some examples, the ball joint assembly 100 may include two or more retainer assemblies 200. In such an example, the first 202 or second 204 retainer assemblies 200 may be a top 202 or bottom retainer assembly 204. In such an example, the first 202 or second retainer assemblies 204 may be the same or similar. In some examples, the first 202 or second 204 retainer assemblies may include, or lack, different features. In one example, a first retainer assembly 202 may include a retainer 210 defining a protrusion 240, or alternatively a key recess, and the second retainer assembly 204 may include the other of the protrusion 240 or key recess, or lack a protrusion 240 or key recess.

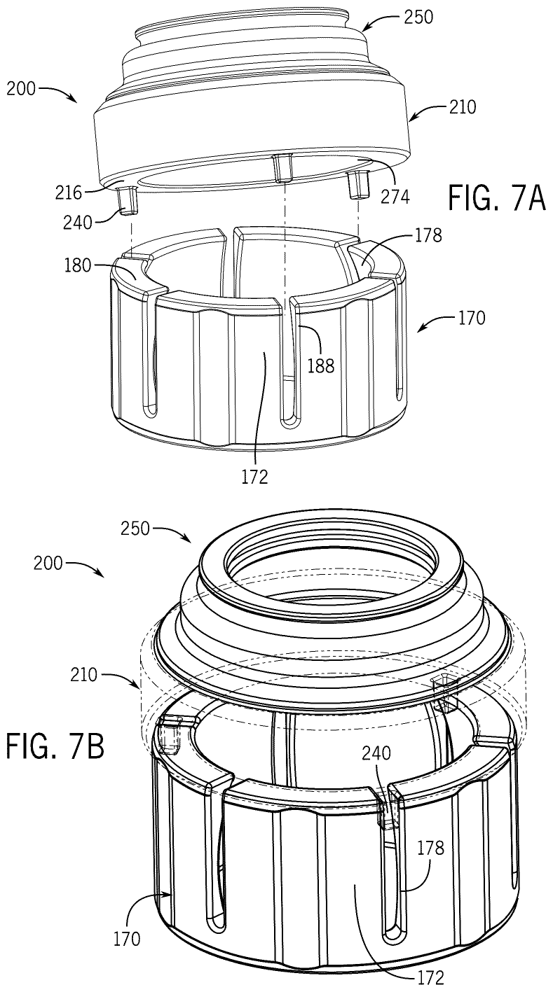

With reference to FIGS. 7A and 7B, the retainer assembly 200 and the race 170 may be positioned in a corresponding engagement. As discussed herein, the race 170 includes one or more annular walls 172 defining a seat recess 188. The annular walls 172 may define or be separated by one or more key recesses 188. The key recesses 188 may be defined, at least in part, in an axial orientation. In some examples, the race 170 may alternatively, or additionally, define one or more of the protrusions 240. In such an example, the race 170 may additionally include key recesses 188.

The retainer assembly 200 may include a retainer 210 defining one or more protrusions 240. The protrusions 240 may extend, at least in part, in the axial direction of the key recesses 188. In some examples, the retainer 210 may alternatively, or additionally, define the one or more key recesses 188. In such an example, the retainer 210 may additionally include protrusions 240.

The retainer assembly 200 may be axially aligned and engaged with the race 170. For example, the bottom 216 of the retainer 210 may be positioned at or in contact with the top of the race 170. The engagement may be a keyed engagement. For example, at least one protrusion 240 of one of the race 170 or retainer 210 engages a corresponding key recess 188 of the other of the race 170 or retainer 210 to restrict relative movement between the race 170 and the retainer 210. The protrusion 240 may be in contact with one or more surfaces of the race 170 when positioned in the key recess 188. In some examples, the protrusions 240 may be additionally, or alternatively, received in the second or top key recess 190.

The protrusions 240 or key recesses 188 may be similarly spaced annularly or regularly about the retainer 210 or race 170, respectively. The number and spacing of the protrusions 240 may correspond to the number and spacing of the key recesses 188. For example, the retainer or ring 210 may define a number of protrusions 240 equal to or less than the number of key recesses 188.

In some examples, the race 170 may define more key recesses 188 than the number of protrusions 240 to assist in aligning the race 170 and retainer assembly 200 for engagement. For example, the race 170 may define a number of key recesses 188 that is a multiple of the number of protrusions 240, such as twice as many. In such an example, multiple rotational orientations of the retainer assembly 200 may engage with the race 170, reducing a difficulty of assembly.

The multiple orientations, or the tapered shape of the protrusions 240, may be especially beneficial for assembling ball and joint assemblies given the small dimensions and tight tolerances between the parts, such as relative to the housing 130 as discussed herein.

In some examples, the protrusion 240 may be tapered along a height 244. For example, the width 242 or depth 246 may vary. The taper of the protrusion 240 may assist in positioning the protrusions in the key recess 188. For example, the distal end of the protrusion 240 may provide an increased tolerance for initially aligning the protrusion 240 within a seat recess 178. Further, the taper may assist in positioning a protrusion 240 where at least a base width 242 or depth 246 may have a dimension equal to or greater than a corresponding dimension of the recess 188. An interference fit between the race 170 and retainer 210 may further limit relative movement of the race 170 and retainer assembly 200. In some examples, the taper may also reduce stress concentrations or a moment at the protrusion 240 resulting from resisting rotation of the race 170.

As discussed herein, during use of the ball joint assembly 100, movement of a race 170 relative to the other components may result in lash, or unconstrained movement of the joint 100 resulting in roughness, noise, binding, or vibrations, which is considered a failure of a joint assembly 100. Limiting movement of the race 170 may limit or reduce lash, or the development of lash. Further, as discussed herein, the retainer 210 may be less likely to develop lash, or require a longer duration of use before lash develops. Accordingly, constraining movement of the race 170 relative to retainer assembly 200 may reduce or prevent lash and increase a life of a ball joint assembly 100.

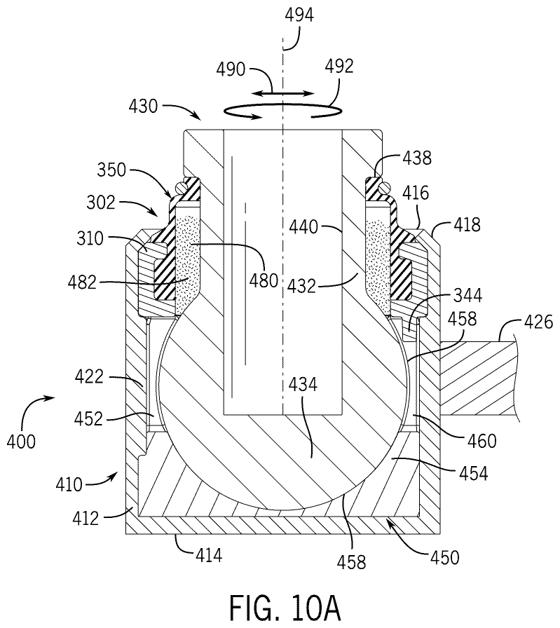

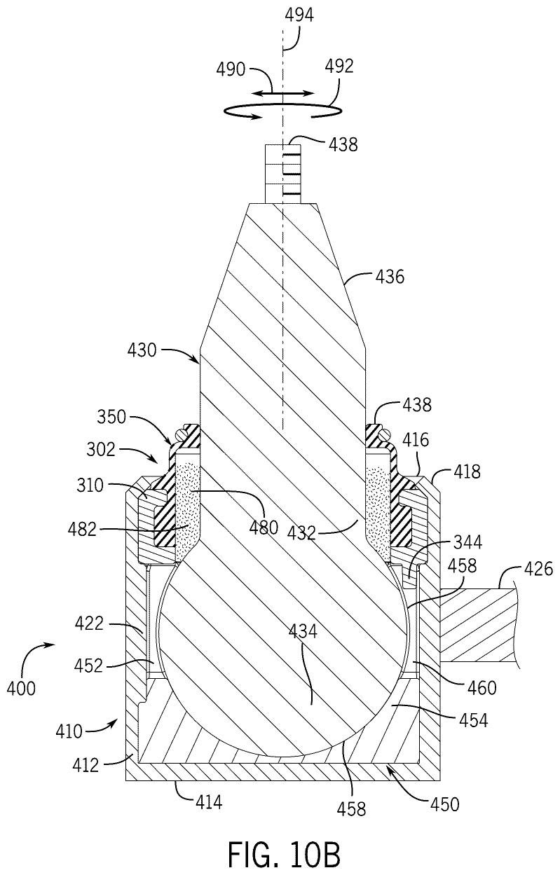

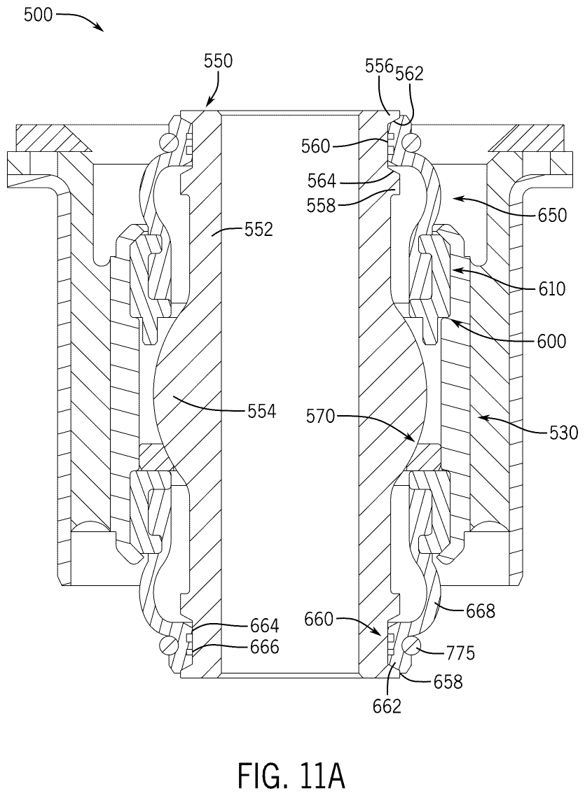

With reference to FIGS. 1A-2 and 8, the various components described herein may be operatively connected to define the ball joint assembly 100. In one example, the ball joint assembly 100 is a cross-axis ball joint. A cross-axis ball joint 100 includes a movable shaft 150, or similar feature, having at least two features extending outward from the chamber 134 of the housing 130. The two features may be connectable with or at two or more components separate from the ball joint assembly 100. In other examples, the ball joint assembly 100 may include only a single extending feature, as may be exemplified in FIG. 10A or 10B.

While specific steps or orders of steps of the assembly presented herein have been illustrated and are discussed, other methods (including more, fewer, a different order, or different steps) consistent with the teachings presented herein are also envisioned and encompassed with the present disclosure. Further, directional references discussed herein are for identification purposes. It is understood the ball joint 100 may be assembled, oriented, or used in various orientations. For example, reference to a top or upper feature may be alternatively or similarly characterized as an outer feature in relation to an inner feature, or a first or second feature in relation to a similar feature, such as on an opposing side, of the joint. In some examples, the joint is symmetrical and reference to upper or lower is used to separately identify a corresponding, but different, feature with reference to a specific orientation illustrated in the figures. In such an example, the other of a feature characterized as lower or upper can alternatively be positioned above or below the component identified as the upper or lower feature. Similarly, use of terms such as right, left, lower, inward, or outward oriented or positioned feature may be oriented or positioned differently depending on an observer's frame of reference as would be understood by a person of ordinary skill in the art.

The movable shaft 150 may be received by the race 170. The movable shaft 150 may rotatably connect with or be received by the race 170. For example, the ball portion 154 may be received or positioned in the seat recess 178. The seat recess 178 may be defined by the race walls 172 to retain the ball portion 154. In some examples, the concave curvature of the seat recess 178 may correspond to or extend over a widest portion of the ball 154. The seat recess 178 may limit axial or radial movement of the movable shaft 150 or ball relative to the race 170. In some examples, two or more races 170 may be used to together constrain the movable shaft 150. To receive the ball 154, the walls 172 may resiliently deflect or flex to widen the seat recess 178. The walls 172 may be at least partially separated by key recesses 178 such that each wall 172 may flex or move relative to the other walls 172, such as outwardly.

The stud 152 may extend from or through the race 170. For example, the seat recess 178 may be an aperture through the race 170 and a stud 152 may extend through or out from the seat recess 178. In examples including two studs 152, a first stud may extend through or from the seat recess 178 at a first end of the race 170, such as the bottom 182, and the second stud may extend from the seat recess 178 at an opposing or second end of the race 170, such as the top 180.

The race 170 and movable shaft 150 may be positioned within the chamber 134 of the housing 130. The race 170 may be press fit within the chamber 134. For example, the exterior 184 of the race 170 may have a corresponding shape and size to a portion of the chamber 134 of the housing 130. The race 170 may be positioned in contact with the housing interior flange 136. The race 170 may have a diameter similar to or greater than the second or flange diameter 146 of the housing 130. In some examples, a race 170 having a greater diameter than the flange diameter 146, may compress or deflect inwardly to define an interference fit. The press fit or interference fit may provide sufficient friction to limit movement of the race 170 relative to the housing.

In some examples, such as where the race 170 includes a key recess 192 defined at least partially by the exterior 184 of the race 170, the housing 130 may define a corresponding protrusion that is received in the recess 192. The key recess 192 or the protrusion may define a keyed engagement to limit movement of the race 170 relative to the housing 130. In such examples, the recess 192 or protrusion, may be defined with an axially sloped surface to assist in aligning the race 170 or housing 130, or to prevent damage to an exterior 184 of the race 170 adjacent the recess 192.

With the race 170 positioned in the chamber 134 of the housing 130, the movable shaft 150 may similarly be positioned within the chamber 134. The at least one stud 152 may extend from the chamber 134. For example, the stud 152 may extend from the ball 154 a sufficient length to at least partially extend from the chamber 134. In some examples, a first stud 152 may extend from the chamber 134 at a first end of the housing 130, and a second stud may extend from the chamber 134 at a second, or opposing, end of the housing 130.

A retainer assembly 200 may be positioned in the chamber 134 of the housing 130. In some examples, a first retainer assembly 202 may be positioned in the chamber 134 at one end of the housing 130, and a second retainer assembly 204 may be positioned in the chamber 134 at a second end.

The retainer assembly 200 may be positioned in the chamber 134 in contact with a chamber shelf 140, or the housing flange 136. For example, the retainer assembly 200 may be placed in the housing 130 until a bottom 216 of the retainer assembly 200 engages the shelf 140. Accordingly, the shelf 140 may be used to define a consistent depth or position of a retainer assembly 200 in the chamber 134 during assembly.

The retainer assembly 200 may be positioned, at least in part, in the chamber 134 by a press fit engagement with the housing 130. The retainer assembly 200 may have a shape or diameter similar to the race walls 172 or upper chamber diameter 145, respectively. In some examples, the retainer assembly 200 may have a diameter greater than the diameter 145 and one, or both, of the housing walls 132 and the retainer 210 may flex inward or outward, respectively. The press fit engagement between the retainer assembly 200 and the housing 130 may frictionally resist rotational movement of the retainer assembly 200 relative to the housing 130. In some examples, the exterior 220 of the retainer 210 or the interior of the housing 130 may have a rough, unfinished, or porous surface to increase the frictional resistance of the press fit engagement. In some examples, the retainer 210 or the housing 130 may define a radially oriented recess and a corresponding protrusion for a keyed engagement between the housing 130 and the retainer 210 to limit rotation.

As discussed herein, the retainer assembly 200 may be positioned within the chamber 134 in engagement with the race 170. For example, the retainer assembly 200 and the race 170 may be positioned in a keyed engagement. In the keyed engagement, at least one protrusion 240 of one of the race 170 or retainer assembly 200 (e.g. retainer 210) engages a corresponding key recess 188 of the other of the race 170 or retainer assembly 200. The keyed engagement may restrict relative movement between the race 170 and the retainer 200 assembly. In some examples, one of the first 202 or second retainer assemblies 204 may lack a protrusion 240 or key recess 188. In such an example, a surface, such as a bottom 216, of the one of the first or second retainer 202, 204 may be positioned in contact or engagement with a surface of the race 170. For example, the second retainer assembly 204 may be in contact with a bottom 182 of the race 170.

In some examples, the race 170 may have an axial height greater than the interior housing flange 136. For example, a portion of the race 170 may extend at least partially above or below a shelf 140. In such an example, the retainer assembly 200 may compressively engage the race 170. In the compressive engagement, the retainer assembly 200 may compressively reduce the height of the race 170 causing outward deflection of the race 170, at least in part. The outward deflection of the race 170 may increase frictional contact between the race 170 and the housing 130 to further limit or reduce rotation of the race 170 relative to the housing 130.

The compressive engagement may limit or reduce axial movement of the race 170 relative to the housing 130 or retainer assembly 200. The compressive engagement may eliminate, reduce, or prevent the formation of voids or gaps between the race 170, and the retainer assembly 200, movable shaft 150, or housing 130. For example, gaps may form due to compounding tolerances or variations in components sizes. In some examples, the compressive engagement of the race 170 and retainer 200 may improve the keyed engagement, such as by positioning a protrusion 240 further in a key recess 188.

With the retainer assembly 200 engaged with the race 170, the movable shaft 150 may extend at least partially through the retainer assembly 200. For example, the movable shaft 150 may extend through the retainer assembly aperture 274. The retainer assembly 200 may be placed in the housing 130 or chamber 134 by inserting the stud 152 through the retainer assembly aperture 274.

The retainer 210 of the retainer assembly 250 may be spaced from the movable shaft 150, such as the ball 154 and stud 152, in an assembled configuration. For example, the diameter of the retainer 210 may be greater than at least an adjacent portion of the stud 152. Accordingly, the stud 152 may pass through the retainer 210. At least a portion of the flexible seal 250 may be annularly spaced from the stud 152. For example, the extension portion 256 may be spaced from the movable shaft 150. The upper annular feature 254 may be a single contact point between the seal 250 and the movable shaft 150.

During assembly, the flexible seal 250 may resiliently flex or stretch to receive the stud 152. For example, a portion of the stud 152, such as the flange 156, may have a diameter greater than the upper aperture 258 of the seal 250. In such an example, the upper annular feature 252 of the seal 250 may resiliently flex or deform to enable the passage of the flange 156 or stud 152. The stud 152 may be retained in the upper aperture 258. For example, the upper annular feature 252 may have sufficient tension to return to an original diameter, or to a diameter of corresponding to the perimeter of the portion of the stud 152, to define an upper sealed connection.

In some examples, the upper annular feature 252 may be retained in or positioned in contact with a seat 158 defined by the stud 152 or flange 156. In some examples, the seat 158 may be an underside of the flange 156. The seat 158 may limit or reduce axial movement of the upper annular feature 252 relative to the stud 152. In some examples, the seal 250 may be stretched under a sufficient tension by the stud 152 to remain in contact with the stud 152. In some examples, the connection between the stud 152 and the seal 250 may be a static seal or allowing limited relative movement between the stud 152 and seal 250. In other examples, the seal 250 may slidably move responsive to movement of the movable shaft 150.

In some examples, the ball joint assembly 100 may include a connecting part 275. The connecting part 275 may be a spring, clip, sleeve, or the like. In various examples, the connecting part 275 is an O-ring or split O-ring. The connecting part 275 may connect or bolster the connection between the stud 152 and the flexible seal 250. For example, the connecting part 275 may be resiliently and impart a force to return to an initial shape or size when stretched. The connecting part 275 can be one or more of a polymer, metal, elastomer, or the like. In one example, the connecting party 275 is an elastomer to reduce complexity in tolerances for the joint assembly 100. When connected, the connecting part 275 may compress the flexible seal 250 against the stud 152. The connecting part 275 may be annularly shaped or adaptively correspond to a shape of the stud 152. In some examples, the connecting part 275 may be received by the recess 262 defined by the upper annular feature 252.

By positioning a retainer assembly 200 (e.g. a seal 250) at each (e.g. the single or both) ends of movable shaft 150, the ball joint assembly 100 may define a sealed volume 280. The sealed volume 280 may be a grease reservoir 280 to retain a lubricating fluid or grease 282. The grease reservoir 280 may be defined, at least in part, between the movable shaft 150 and the retainer assembly 200. The grease reservoir 280 may be continuously and annularly defined about the movable shaft 150. For example, the stud 152 and ball 154 may define an interior boundary and the retainer 210 and seal 250 may define an outer boundary of the grease reservoir 280. The upper annular feature 252, or upper seal connection, may define an upper or lower boundary of the grease reservoir 280. As discussed herein, because the retainer assembly 200 of the present invention may not require separate features to connect a separate seal to the retainer 210, the grease reservoir 280 may have a comparatively increased volume. In one example, the grease reservoir may retain approximately 0.2 to 0.9 grams, inclusive, of grease 282. The grease 282 may lubricate the bearing surface, such as the bearing recess or seat 178 or the ball 154, to reduce friction and wear between the movable shaft 150 and the race 170. The grease 282 may trap or repel contaminants. For example, grease 282 may be hydrophobic or resistant to mixing with at least some fluids. The grease 282 may similarly repel or trap solid contaminants. In some examples, the grease 282 may lubricate contaminants, reducing their respective wear or friction in the ball joint assembly 100.

With the retainer assembly 200 positioned within the housing 130, the housing 130 may be shaped, or an additional feature may be coupled to the housing 130, to inhibit removal of the retainer 200 from the chamber 134. In some examples, the housing 130 may optionally include the lip 148 extending about the chamber 134 of the housing 130.

The lip 148 may be defined after positioning the retainer 200 in the chamber 134. For example, the retainer assembly 200 may be positioned in the chamber 134 and an end of the housing 130 may be at least partially folded or bent to define the lip 148. The lip 148 may have define a reduced diameter of the chamber 134, less than a diameter of the retainer 200, inhibiting removal. The lip 148 may contact the retainer assembly 200, such as at the retainer 210. The lip 148 may apply pressure to or limit axial movement of the retainer assembly 200 to secure the retainer assembly 200 within the chamber 134. The lip 148 may be in contact with the retainer assembly 200 and generate friction between the retainer 200 and housing 130, resisting potential rotation of the retainer assembly 200 relative to the housing 130.

In some examples, the swaging may provide a compressive force for the compressive engagement of the retainer assembly 200 and race 170. In such an example, both ends of a housing 130 may be swaged together to assist in aligning the parts or maintain consistent compressive forces, such as at a first retainer 202 and a second retainer 204. In some examples, the lip 148 may extend to the seal 250. In such an example, the lip 148 may have a sealing engagement with the seal 250 to seal the chamber 134, at least in part. In some examples, the lip 148 may be spaced from the seal 250 and the race 170 or retainer 210 may be in sufficient contact with the housing 130 to limit or prevent, at least in part, ingress or egress from the housing 130.

In some examples, the ball and joint assembly 100 optionally includes the outer casing 102. In such an example, the housing 130 may be received in the casing aperture 120. The housing 130 may be press fit within the casing aperture 120. In some examples, the bushing 112 may be in contact with the exterior of the housing 130. For example, the housing 130 may be placed and suspended in the bushing 112. The outer shell 104 may be received by or positioned in contact with a feature of a separate device, such as an automotive linkage. The bushing 112 may absorb or disperse received forces to limit damage to the housing 130.

The ball joint assembly 100 may be connected to two or more separate features. For example, a feature may be in contact or engagement with the housing 130 or outer casing 102. A second feature may be operatively connected with the movable shaft 150, such as at the stud 152. For example, a feature may be received in the shaft aperture 162 or connected to the exterior of the stud 152. In some examples, the ball joint assembly 100 may be retained by or operatively connected to a first feature, such as at the outer casing 102 or housing 130, and separately and additionally connected to two separate features, such as by the movable shaft 150.

The ball joint assembly 100 may be annually arranged or extend about a longitudinal axis 294. The ball joint assembly 100 in use may enable movement between two features by rotation of the movable shaft 150 relative to the housing 130 or outer casing 102. In common applications of a ball joint assembly 100, the movable shaft 150 may support a load on the ball joint assembly 100. The movable shaft 150 may commonly support a load primarily parallel to or orthogonal to the axis 294. The movable shaft 150 and the race 170 may define a primary wear or bearing surface for rotational movement of the movable shaft 150.

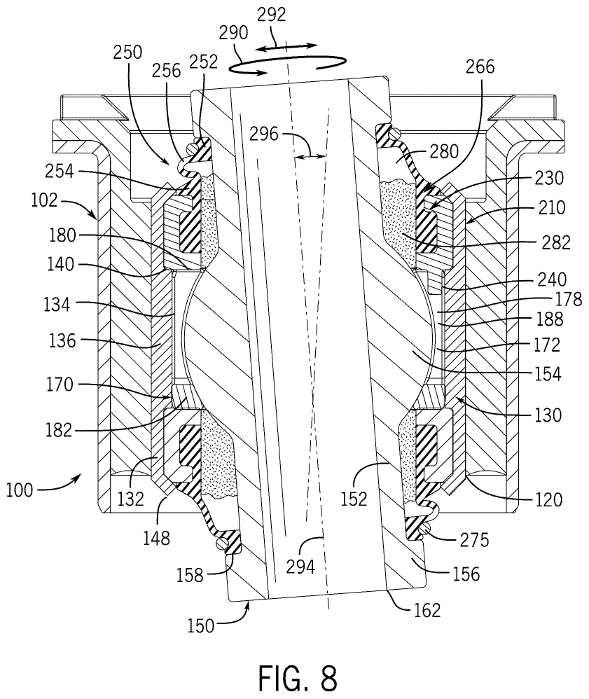

With reference to FIG. 8, the movable shaft 150 may laterally or radially move 292 or move by angular rotation 290 relative to the axis 294 (e.g. orthogonally relative to the axis 294). For example, the movable shaft 150 may radially move by an angle 296 to the axis 294 relative to an initial configuration. The angle 296 may be in any orientation relative to or about the axis 294. In some examples, an end of the movable shaft 150 may be rotated or positioned at an angle 296 relative to the axis 294 between −20 degrees and 20 degrees, or commonly between −10 degrees and 10 degrees, inclusive, for a total angular range having a magnitude between 0 and 40 degrees. For example, either end of the movable shaft 150 may have a combined offset 296 between −40 and 40 degrees relative to the other end. As a result, the ball joint assembly 100 may enable relative movement between connected features to the ball assembly 100 while constraining axial spacing between the components.

A common failure mode of ball joint assemblies 100 is corrosion and wear from the ingress of contaminants. Corrosion and debris ingress increase wear within a bearing system, which may ultimately lead to the development of lash or noise, vibrations, and harshness. For example, where ball joints may be located on a vehicle, such as control arms or other locations exposed to harsh environmental conditions and, as a result, may be routinely bombarded with solid and liquid road debris. To limit corrosion, existing ball joint assemblies have included a boot to act as a barrier. However, the existing boots have been separate features that are separately attached to a ball joint. To accommodate the assembly, joints often must be larger in size in order to provide sufficient clearance to mount the boot and affix boot retainment parts. The separate and larger boots may have an insufficient connecting with the ball joint to block contaminants. For example, the boots may buckle or flex and separate from a coupled feature to allow in contaminants. Further, retainment parts used to prevent such separation, such as, wires, clips, and retaining rings, can puncture or pinch a boot, creating a potential leak path, and may be difficult to install. Additional care must be taken when assembling the boot and the boot retention parts to avoid puncturing or warping the boot. This additional care adds cost and complexity to the ball joint assembly.

By bonding the seal 250 to the retainer 210, a continuous seal may be defined that limits or prevents ingress at least one end of the seal 250. The flexible seal 250 overmolded to the retainer 210 along a bond surface 230 provides a robust static seal with the retainer 210. The overmolding of the seal 250 to the retainer 210 may prevent ingress of contaminants at the lower annular feature 254. For example, the seal 250 may retain connection with the bond surface 230. The engagement with the bond surface 230, or between the bonding features 266 and bond surface 230 may resist separation at large angular offsets 296 or under high loads or impacts.

When the movable shaft 150, or ball joint assembly 100, is in a rotated configuration, as exemplified in FIG. 8, the flexible seal 250 may flex with the movement of the shaft 150. At an angular offset 296, the upper annular feature 252 may remain in contact with the stud 152. A side or portion of the flexible seal 250, such as the extensions 256, in the direction of the angular offset 296 may fold or bend to accommodate the reduce distance between a retainer 210 and the stud 152. An opposing side or portion of the flexible seal 250, such as the extensions 256, away from the direction of the angular offset 296 may resiliently straighten, elongate, or flex between the retainer 210 and the stud 152. In some examples, the upper annular feature 252 may slidably move along the length of the stud 152 to accommodate large angular offsets 296. In such an example, the tension of upper annular feature 252 or the connecting part 275 may maintain a continuous engagement between the seal 250 and the stud 152. The flexible seal 250 may assist in preserving the grease reservoir 280 and preventing or limiting ingress of contaminants. In some examples, the shape of the grease reservoir 280 may correspondingly change shape while maintaining a volume of grease 282 during movement of the ball joint assembly 100.

In some examples, the movable shaft 150 may at least partially rotate in direction 290 about the long axis 294. In such an example, the connection between the shaft 150 and the flexible seal 250 may similarly be maintained. In some examples, the movable shaft 150, or stud 152, may rotate within the upper opening 258, or relative to the seal 250. In some examples, the seal 250, or upper annular feature 252, may rotate with the movable shaft 150, or stud 152. In either example, the seal 250 may remain in connection with the movable shaft 150. For example, the tension of the annular feature 252 may maintain contact with the stud 152. And even if contaminants ingress at the upper annular feature 252, the connection between the seal 250 and retainer 210 may maintain the grease 282 in the grease reservoir 280 between the upper annular feature 252 and the retainer 210, ball 154, or the interior or chamber 134 of the housing 130.

In some examples, even if contaminants ingress at the upper annular feature 252, the connection between the seal 250 and retainer 210 may maintain the grease 282 in the grease reservoir 280 between the upper annular feature 252 and the retainer 210, ball 154, or the interior or chamber 134 of the housing 130. For example, any opening to the grease volume 280 may be limited to the upper annular feature 252. In such an example, the grease 282 may trap or repel debris. For example, grease 282 block or isolate the fluids. Solid particles may be trapped in the grease 282 and limited from further ingress.

The unitary structure of the retainer assembly 200 can reduce overall size of the ball joint 100. For example, space within the joint for a boot or corresponding retainment part, such as a retaining wire may be eliminated. The bonding of the flexible seal 250 directly to the retainer 210 may eliminate the need for at least one separate connecting feature, reducing cost or risk of damage during assembly of the retainer assembly 200. For example, the separately connected feature used to connect features of a conventional boot seal may be sharp, stiff, or otherwise capable of puncturing or damaging the flexible material of a seal during connection of the seal and retainer. The damage to the boot seal may create openings to permit the entry of contaminants, leaking of any lubricating fluid of a ball joint assembly, or premature failure of the seal. Due to the small size of the ball joint assemblies, the damage may be difficult to identify or detect, at least initially. As a result, a substandard product may go undetected.

The removal of separate attachment means, or a directly bonded seal 250 to the retainer 210 may have a reduced size or proportion of a seal directed to connecting with a retainer 210. For example, space within the joint 100 for a boot retainment part and corresponding sealing feature, such as a retaining wire may no longer be needed. As a result, the retainer assembly 200 requires significantly less space within the joint 100, compared to existing boots, to accomplish equivalent or improved attachment and sealing means. In comparison, a similarly sized ball joint assembly of the present invention may define a retainer assembly aperture 274 may have an increased internal volume instead of space for a separate connecting feature or other external structures. The larger internal volume may retain a larger volume of grease or lubricating fluid 282. The additional lubricating fluid 282 may assist in trapping more contaminants or define a larger barrier between contaminants and components of the bearing assembly 100, reducing or delaying corrosion. The larger volume of grease may also retain a larger total amount of contaminants before the lubricating properties are reduced, increasing a life span of the ball joint assembly 100.

One of the common failure modes in existing ball joints is when a race rotates relative to a housing during operation resulting in lash, or noise, vibration, or the like due to relative movement of components of the joint (e.g. unconstrained movement). For example, the race 170 may be insufficiently constrained relative to the housing, or loading forces may overcome a frictional resistance to rotation between the housing and race. As a result, the intended bearing surface (e.g. ball and race) may no longer act as the primary bearing or rotational surface under these conditions. Rotation of the race against the housing may result in wear on the exterior surfaces of the race, resulting in less contact with the housing or further movement of the race relative to the housing. These wear patterns result in accelerated wear and, ultimately, lash is developed between the ball-and-socket bearing and one or more of the race, retainer assembly, or housing.

To limit movement of the race 170 relative to the housing 130, and the development of lash or space for unintended movement of the movable shaft 150, the race 170 and retainer assembly 200 may be positioned in a keyed engagement within the chamber 134 as discussed herein. The keyed engagement between the protrusion 240 and recess 188 of the retainer assembly 200 and the race 170 may limit, or prevent, movement of the race 170 relative to the retainer. Instead, rotational torque on the race 170 is transmitted to the retainer 200 by the keyed relationship. The press fit of the retainer 200 may have a greater frictional resistance to rotation than the race 170. In some examples, the retainer assembly 200 may have a greater surface area in contact with the housing 130 and thereby have a greater frictional resistance to rotation. In some examples, the race 170 and retainer 200 may each contribute to a greater frictional resistance to rotation relative to the housing 130. In some examples, the swage lip 148 may increase friction, or otherwise assist in constraining the retainer 200 relative to the housing 130.

The retainer 200 may be more durable than the race 170 and may resist wear with or by the housing 130. In some examples, the retainer 200 may resist wear for a longer duration before lash develops than a race, providing an increased life span for a ball joint assembly 100.

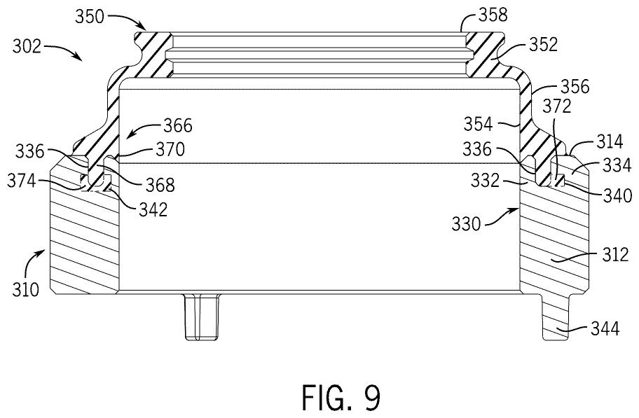

Turning to FIG. 9, a second example of a retainer assembly 302 is shown. The retainer assembly 302 may be or include similar features as the retainer assembly 200. In some examples, the retainer assembly 302 may replace the retainer assembly 200, or one of the upper or lower retainer assemblies 202, 204.

The retainer assembly 302 may similarly include a retainer 310 and a flexible seal 350. The retainer 310 may be defined by an annular wall or ring 312. The retainer 310 may have a top 314, bottom 316, interior 318, and exterior 320. The interior 318 may define an aperture 324 through the retainer 310. The retainer 310 may similarly include one or more protrusions 344 extending from the retainer 310.

The retainer 310 may define a bond surface 330. The retainer assembly 302 may be characterized by a bond surface 330 defined by radially spaced or axially extending features. The bond surface 330 may be defined along or by the top 314 of the retainer 310. The bond surface 330 may include a first axial projection 332. The first axial projection 332 may be defined at or adjacent the aperture 322. The first axial projection 332 may extend annularly about the retainer 310. The bond surface 330 may include a second axial projection 334. The second axial projection 334 may be spaced from the first axial projection 332, such as radially. The second axial projection 334 may extend annularly about the retainer 310.

The retainer 310 may define a recess 336 between the first 332 and second 334 axial projections. The recess 336 may extend, at least partially, axially into the retainer 310. In some examples, the recess 336 may be defined with an, at least partially, radially oriented portion 340, 342. The radially oriented portion 340 of the recess 336 may be a portion having a width (e.g. radial dimension) greater than an entrance of the recess 336. In one example, an annular portion 340 may be defined extending radially outward or inward. For example, the annular portion 340 may be defined under one of the first 332 or second 334 axial projections. In another example, a radial portion 342 may be defined extending radially outward and inward. For example, the radial portion 340 may be defined under the first 332 and second 334 axial projections. The radial portions 340, 342 of the recess 336 may be rectangular, elliptical, or a variety of other cross-sectional shapes.

The flexible seal 350 may include some of the same or similar features of the flexible seal 250. For example, the flexible seal 350 may include an upper annular feature 352 and a lower annular feature 354, connected by an extension 356. The seal 350 may define an aperture 358 extending there through.

The lower annular feature 354 may define securement features 366. The securement features 366 of the seal 350 may be radially spaced or axially extending features. For example, the securement feature 366 may include a flange 368 extending axially from the lower annular feature 354. The flange 368 may extend annularly along the lower annular feature 354. In some examples, the securement feature 366 includes a second flange 370. The second flange 370 may similarly extend annularly about the lower annular feature 354.

One or both of the first 368 or second annular flange 370 may include a radially extending portion 372, 374. In one example, either flange 368, 370 may include a single radially extending portion 372. The single radially extending portion 372 may have an increased width or extend from the flange 368, 370 in a single radial direction. In one example, either flange 368, 370 may include a dual radially extending portion 374. The dual radially extending portion 374 may have an increased width or extend from the flange 368, 370 in at least two directions having opposing radial directions. The radially extending portions 372, 374 may extend from the flanges 368, 370 at any point spaced from the base of the flanges 368, 370.

The flexible seal 350 may be a thermoplastic. For example, the flexible seal 350 may be neoprene. The flexible seal 350 may be formed by injection molding. The flexible seal 350 may be bonded to the retainer 310 to define the retainer assembly 302. The flexible seal 350 may be overmolded to the retainer 310. For example, the flexible seal 350 may be injection molded with or to the retainer 310, at least in part. In at least one example, the bonding features 366, or the lower annular feature 354, may be formed by injection molding the material of the flexible seal 350 at the bond surface 330. In such an example, the bond surface 330 may at least partially define the bonding features 366. For example, the flanges 368, 370 may be formed corresponding the shape and configuration of the axial projections 332, 334 or recess 336. In such an example, the radial extending portions 372, 374 may be formed by and retained in the radial portions 340, 342 of the recess 336.

The flexible seal 350 overmolded to the retainer 310 along a bond surface 330 to provide a robust static seal for the retainer assembly 302. For example, the projections 332, 334 or recesses 336 of the bond surface 330 may increase a surface area and strength of the overmold bond between the retainer 310 and flexible seal 350, resisting separation to increase a life of the retainer assembly 302 or seal.

In examples including the radial portions 372, 374 from the flanges 368, 370 or the radial portions 340, 342 of the recess 336, a mechanical interference between the seal 350 and retainer 310 may be defined. For example, the dimensions of the radial portions 372, 374 may inhibit or resist removal of one or both of the flanges 368, 370 from the recess 336. The mechanical interference between the flange 368 and the recess 336 may resist separation of the seal 350 and retainer 310 to increase a life of the retainer assembly 302 or seal.

Turning to FIG. 10A, an example of a ball joint assembly 400 is shown. The ball joint assembly 400 may include a movable shaft 430 with a single stud 432, or a housing 410 having a single opening 416. The ball joint assembly 400 may be designed for pivotal rotation 492 or radial movement 490 relative to the axis of rotation 494. For example, a connected component moves relative to the position of the ball joint assembly 400, or a second component connected with the ball joint assembly 400.

The ball joint assembly 400 includes a housing 410. In some examples, the housing 410 may be the outermost feature of the ball joint assembly 400. The housing 410 may define a chamber 416 by an annular wall 412. The chamber 416 may have a single opening, extending to a bottom 414 of the housing 410. The housing 410 may define interior features similar to the housing 130, such as defining an interior extending flange 422. The housing 410 may include an external shaft 426 for coupling to an external feature.

The ball joint assembly 400 may include a movable shaft 430. The movable shaft 430 may be similar to the movable shaft 150 and include a ball 434 and a stud 432 extending axially from the ball 434. The movable shaft 430 may include only a single stud 432. In some examples, the movable shaft 430 defines an aperture or recess 440 extending at least partially inward along the stud 432.

The ball joint assembly 400 may include a race 450. The race 450 may be similar to the race 170 and include one or more annular arranged walls 452. The walls 452 may extend from a base 454 of the race 450. The race 450, or walls 452, may define a seat recess 458. The seat recess 458 may be concave or smooth. For example, the walls 452 may define a spherical volume of the seat recess 458. The seat recess 458 may only extend partially through the race 450. For example, the seat recess 458 may define a bearing surface having at least a bottom and sides. The walls 452 may be spaced by or define a key recess 460. The key recess 460 may be similar to either or both the key recesses 188, 190.

The ball joint assembly 400 may include a retainer assembly the same or similar as the retainer assemblies 200, 302. For example, the retainer assembly may be the retainer assembly 302. The ball joint assembly 400 may include only a single retainer assembly 200, 302.

The ball joint assembly 400 may be similarly assembled as ball joint assembly 100. For example, the race 450 may resiliently deflect to receive the movable shaft 430. For example, the ball 434 may be placed in the seat recess 458. The race 450 and the movable shaft 430 may be positioned in the chamber 416 with at least a portion of the stud 432 extending from the chamber 416.

The retainer assembly 200, 302 may be positioned in the chamber 416 in keyed engagement with the race 450. For example, the retainer assembly 200, 302 may similarly position the protrusion 240, 344 in the keyed recess 460. The retainer assembly 200, 302 may similarly connect the flexible seal 250, 350 with the stud 432. For example, the retainer assembly 200, 302 may define a grease volume 480 for retaining grease or other lubricating fluid 482. In some examples, a top 418, or other portion of the housing 410 may be swaged or in contact with the retainer 200, 302. For example, the retainer 200, 302 may be retained in compressive engagement with the race 450. The interior flange 422 may define or determine the depth of the retainer 200, 302 in the housing 410.

During use, the ball joint assembly 400 may allow movement of a part relative to a second and separate part. The movement may be about the ball joint assembly 400, while axially constraining the position of a part connected to the movable shaft 430. For example, the movable shaft 430 may move relative to the axis 494 annularly, such as in direction 492, or laterally 490. In some examples, the ball joint assembly 400 may rotate or move laterally 490 and annularly 492. The retainer 200, 302 and race 450 may constrain the axial movement of the movable shaft 430.

The keyed engagement between the retainer assembly 200, 302 and the race 450 may similarly resist rotation of the race 450 relative to the housing 410 during movement of the movable shaft 430. For example, rotational forces at the race 450, such as from loads imparted by the ball 434, may be imparted to the retainer assembly 200, 302 to resist rotation. In some examples, the retainer assembly 200, 302 may provide compressive engagement with the race 450. The compressive engagement may further increase frictional resistance to rotation, such as against the bottom 414 or walls 412 of the housing 410.

With a single stud 432 ball joint assembly 400, resisting limiting relative movement of the race 450 to the housing 410 may be particularly important to improving the life span of the ball joint 400. For example, the race 450 may have an increased surface area with the housing 410, which may cause lash or wear to progress quickly. Accordingly, having a retainer 310 and a race 450 in a keyed engagement may limit axial rotation of the retainer 310 or race 450 relative to the housing 410, thereby reducing or preventing the development of lash.

Turning to FIG. 10B, another example of a ball joint assembly 402 is depicted. The ball joint assembly 402 may be similar to the ball joint assembly 400 and include a retainer assembly 302, housing 410, and race 450. For example, the ball joint assembly 402 may include a movable shaft 430 with a single stud 432, or a housing 410 having a single opening 416. The ball joint assembly 400 may similarly be designed for pivotal rotation 490, 494 of a connected component relative to the ball joint assembly 400, or second component connected with the ball joint assembly 400.

The stud 432 of the ball joint assembly 402 may include an elongated or taper shaft portion 436. For example, the elongated portion 436 may taper from a first width or diameter adjacent the housing 410, such as at the opening 416, or the retainer assembly 302, to a second width at a distal end 438. The distal end 438 may be shaped to mate or connect with a secondary component or assembly, such as a component of an automotive assembly. The distal end 438 may similarly be tapered or threaded, recessed, or include similar features to assist in mating with a secondary component.

In one example, the elongated portion 436 may be between 20 mm and 1 cm from the retainer assembly 302 to the distal end 438. In one example, the elongated portion is 25 mm. The distal end 438 may have a length in addition to or defining a portion of the length of the elongated portion. In some examples, the distal end 438 is between 15 mm and 50 mm. The tapering of the elongated portion 436 may change in width between a ratio of 1:2 and 1:8, and in one example 1:6.

The elongated portion 436 may extend the distance from the housing 410 to assist in connecting between two spaced secondary components. In some examples, the length of the elongated portion may enable a greater total distance of movement at the distal end 438 relative to the housing 410, thereby increase a range of motion of the secondary components, such as a suspension system.

For example, the movable shaft 430 of ball joint assemblies 400, 402 may move laterally or radially 490 or by angular rotation 492 relative to the axis 494 similar to the ball joint assembly 100. In some examples, an end of the movable shaft 430, such as the distal end 438, may be rotated or positioned at an angle relative to the axis 494 between −20 degrees and 20 degrees, or commonly between −10 degrees and 10 degrees, inclusive, for a total angular range having a magnitude between 0 and 40 degrees.

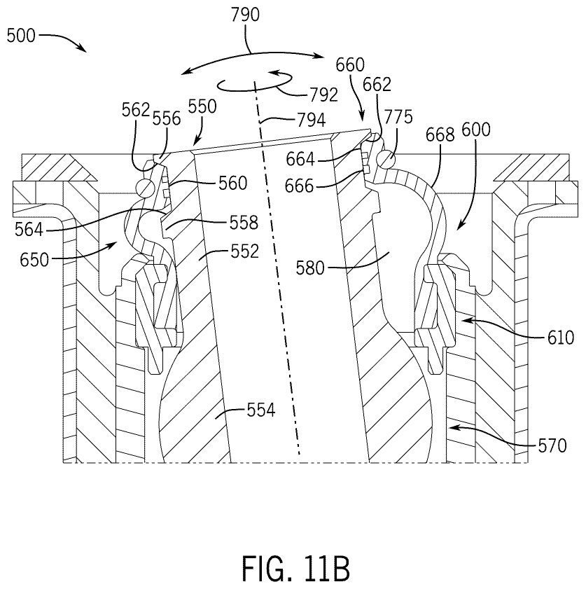

Turning to FIGS. 11A and 11B, another example of a ball joint assembly 500 is illustrated and may include similar or different features or teachings of the ball joint assemblies described herein, such as ball joint assembly 100 (FIGS. 1-9) or ball joint assemblies 400, 402 (FIGS. 10A and 10B). For example, the ball joint assembly 500 includes a movable shaft 550 selectively held in place by a retainer assembly 600 in keyed engagement with a race 570. The shaft 550, retainer assembly 600, and race 570 can be positioned within a housing 530. As described previously, the keyed engagement between the retainer assembly 600 and race 570 can prevent or limit the development of lash and increase the longevity of the ball joint assembly 500.

The ball joint assembly 500 includes a movable shaft 550 and seal 650 shaped to enhance engagement between the seal 650 and shaft 550, and also to limit wear between the seal 650 and shaft 550 during use.

With reference to the lower end, which can be the same or similar to an opposing or upper end, of the joint assembly 500, the seal 650 of the retainer assembly 600 includes an outer or portion 660 defining an opening 658 for the stud 552 of the shaft to pass through. In one example, the outer portion 660 defines a rim 662 having an inner surface or edge 664 that defines the opening 658. The rim 662 may define tapered cross-sectional profile, sloping downward from an exterior or outer end (e.g. bottom or top with reference to FIG. 11A or 11B) of the seal 650 and inward to the inner edge 664. The inner edge 664 may include at least two recesses 666 extending at least partially, and in some examples continuously, around the inner edge 664. For example, the recesses 666 may define a rib therebetween, forming a ribbed or labyrinth-like structure on the inner edge 664. This contacts the outer surface of the shaft 550 to define and seal an interior or grease volume 580. An extension wall 668 extends between the outer feature 660 and the retainer 610 (e.g. an inner portion of the seal 650) of the retainer assembly 600.

The shaft 550 includes at least one stud 552 and a ball portion 554. The stud 552 in one example may be a cylindrical shaft extending outwardly from the ball portion 554. The stud 552 includes a first flange 556 extending at least partially or, in some examples, circumferentially around the stud 552 at or adjacent an end of the stud 552. A second flange 558 extends at least partially or circumferentially around the stud 552 and is spaced from the first flange 556 to define a seal retention trough or groove 560.

The first flange 556 extends outward from the stud 552. The first flange 556 and the second flange 558 may each define a tapered surface or seat 562, 564 respectively. The tapered surfaces 562, 564 define the side walls of the retention trough or groove 560, and each may be angled or curved in profile. The trough 560 in one example defines a recessed or depressed region extending circumferentially around the stud 552 between the two flanges 556, 558.

The seal retention trough 560 receives the seal 650. The seal 650 may be shaped at least in part to conform to one or both of the surfaces 562, 564. As shown in FIG. 11A, the seal 650 is shaped to conform to surface 562. The conforming shape may help seal the grease reservoir 580 and enable relative rotation of the shaft 550 relative to the seal 650.

During assembly, the movable shaft 550 is engaged with the seal 650. For example, at least one stud 552 extends into and through an opening 648. The outer or upper annular feature 660 is received at or positioned in the trough 560. The rim 662 is positioned in contact with the first flange 556 (e.g. the seat). The rim 662 and the seat 562 can have the same or similar tapered profiles such that the surfaces are in contact along their length. The portion of the interior surface 664 defining the annular recess 666 of the seal 650 are placed in the trough 560. The connecting feature 775 is placed in contact with the exterior of the seal 550 and compresses the seal 650 against the shaft 550. The grease reservoir 680 is defined, at least in part, between the movable shaft 150 and the retainer assembly 200 (e.g. the stud 552 and the seal 650).

The seal retention trough 560 assists in retention of the seal 650 and lubricated contact between the seal 650 and movable shaft 550. The ball joint assembly 500 is designed for pivotal rotation 792 or radial movement 790 relative to the axis of rotation 790. For example, with reference to FIG. 11B, during use of the joint 500 the movable shaft 550 may rotate 790, 792 relative to the race 570 and retainer assembly 600. During use it is important to maintain contact between the shaft 550 and the seal 650 to retain grease and limit ingress of contaminates into the joint 500. However, radial (e.g. twisting) rotation 792, movement between the shaft 550 and the seal 650 is necessary to prevent binding or twisting of the seal 650. This relative motion can cause wear and between the engagement surfaces of a shaft and seal, resulting in ingress of contaminants over time.

The ball joint assembly 500 of the present example provides improved engagement between the seal and movable shaft 550 during pivotal rotation 790. For example, the tapered profile 562, 564 of either or both flanges 556, 558, and the trough 560, each contribute to homing or locating the seal 650 in engagement with the movable shaft 550.

As shown in FIG. 11B, pivotal movement of the shaft 550 biases the seal 650 to move outward or upward, or downward or inward, on opposing sides (e.g. lengthen or compress extension wall 668) of the shaft 550. As a result, the seal 650 may be at least partially biased by a force from the rotation 790 to move upward (e.g. outward) or downward (e.g. inward) along the shaft 550. The first flange 556 and tapered profile 562 limit outward movement of the seal 650 and direct the seal 650 (e.g. outer feature 660) towards the trough. For example, the compressive force from a connecting feature 775 may direct the seal 650 towards the trough 560 (e.g. inward along the first flange 556). The tapered profile 562 of the first flange 556 and the rim 662 can also increase the total contact surface area oriented in or along the direction of the axis of rotation 794 to provide increased friction between the seal 650 and the flange 556 to resist outward or inward (e.g. upward or downward) movement. The second flange 568 and tapered profile 564 limit inward (e.g. downward) movement, and in some examples sagging of the seal 650, and direct the seal 650 towards the first flange 556 and trough 560. As a result, the seal 650 and the shaft 550 maintain engagement during use to prevent ingress of contaminants.

The improved engagement also enables the use of a seal 650 defining a larger grease volume 658, e.g. rotund or longer extension wall portions 668. A longer or more rotund extension wall portion 668 of the seal 650 may require a stronger engagement to overcome a larger imparted biasing force oriented radially outward on the seal 650 due to the increased grease, and associated pressure due to mass or centrifugal force during use, or length of the seal 650. However, by providing an assembly 500 having an improved engagement that overcomes or resists the biasing forces, a seal 650 with a longer or more rotund extension wall portion 668 can be used without increased risk of ingress of contaminants.

During the radial (e.g. twisting) rotation 792 of the shaft 550 about an axis of rotation 794, movement between the shaft 550 and the seal 650 limits binding or twisting of the seal 650, and further reduces wear generally. When a surface pressure between the seal 650 and shaft 550 is lowered, relative movement between the components results in reduced wear. The tapered shape of the rim 662 and the recesses 666 reduce a surface pressure between the seal 650 and shaft 550 sufficient for relative movement, while maintaining sufficient pressure for engagement between the seal 650 and shaft 550.

The tapered shape of the rim 662 and the first flange 556 provides for an increase in surface area for maintaining engagement, while provide a relatively small increase or a reduced amount of rotational friction or surface pressure. Torque due to friction is proportional to the radius of the engagement surfaces from the axis of rotation 794. As a result, the outer edges of the rim 662 and flange 556 have the greatest radius and thus frictional torque to overcome. However, because the tapered surfaces are oriented at an angle defining reduced radii along the surfaces, the applied frictional force between the seal and flange decreases and is effectively reduced over the engagement area, resulting in a lower frictional force. As a result, the frictional force between the seal 650 and the shaft 550 is decreased while the magnitude of a compressive or engaging force is maintained.

Grease can be applied from the reservoir 580, or in a separate operation, between the seal 650 and shaft 550 to assist in rotation between the features (e.g. reduction in torque from friction), and to limit ingress of contaminants. The trough 560 and tapered flanges 556, 558 can assist in homing or directing grease to flow to the region of the shaft 550 in engagement with the seal 650. In examples where grease is applied to the shaft 550 prior to connection with the seal 650, the trough 560 can retain or store the grease. The recesses 666 of the seal 650 can similarly trap or retain grease to assist in continued lubrication, such as during use or in a preapplication of the grease. The retention of grease provides a reduced coefficient of friction between the seal 650 and shaft 550, thereby reducing the torque imparted on the shaft 550 or seal 650 to overcome friction and enable relative movement. In some examples, the retention of grease (e.g. reduced coefficient of friction) reduces the difficulty of assembly (e.g. inserting the shaft 550 through the seal opening 648). For example, the decreased friction forces may reduce the force required by a user to connect the components.

Further, the reduction is the coefficient of friction reduces the frictional force due to torque between the seal 650 and the shaft 550 for any given pressure or force directing contact between the seal 650 and the shaft 550. As a result, the benefits of the features of the seal 650 and shaft 550 can be appreciated without reducing the strength of the engagement between the seal 650 and shaft 550 to limit ingress of contaminants.

It is appreciated the teachings or features of the various examples of ball joint assemblies described herein may not be limited to the example configuration in which they are described. For example, the features of ball joint assembly 500 can be used in combination with the features of ball joint assembly 100, or the additional examples described herein.

Other examples and implementations are within the scope and spirit of the disclosure and appended claims. For example, features implementing functions may also be physically located at various positions, including being distributed such that described portions of functions are implemented at different physical locations. References to directions, orientations, or the like of the various components may be for identification purposes only, unless otherwise indicated. For example, the identifying terms may be used to merely to assist in identifying features with respect to the illustrated examples in the figures, rather than a requirement that an identified feature must always be in a labeled position or orientation. For example, the assemblies and features described herein may be positioned in numerous relative orientations or configurations without departing from the teachings or functionally as described herein.

Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and Band C). Further, the term “exemplary” does not mean that the described example is preferred or better than other examples.

The foregoing description, for purposes of explanation, uses specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A ball joint assembly comprising:
a housing defining a chamber;
a race positioned in the chamber and defining:
an annular wall including a seat recess;
a movable shaft including a ball and at least one stud extending from the ball, the ball being received in the seat recess and the at least one stud extending out of the chamber; and
a retainer positioned at least partially in the chamber and engaging a surface of the race, and
wherein at least one protrusion of one of the race or the retainer engages a corresponding at least one key recess on the other of the race or the retainer to restrict relative movement between the race and the retainer.

2. The ball joint assembly of claim 1, wherein the at least one protrusion extends from the retainer.

3. The ball joint assembly of claim 1, wherein the at least one key recess is defined at least in part by a top surface of the race.

4. The ball joint assembly of claim 3, wherein the annular wall defines the at least one key recess extending from the seat recess to an exterior of the race.

5. The ball joint assembly of claim 1, wherein:
the race defines the at least one key recess and a second recess,
the retainer defines the at least one protrusion and a second protrusion,
the at least one key recess and the second recess are annularly spaced about the seat recess, and
the at least one protrusion and the second protrusion are correspondingly and annularly spaced about an axially interior surface of the retainer.

6. The ball joint assembly of claim 1, wherein:
the at least one protrusion extends from the race; and
the at least one key recess is defined at least in part by the retainer.

7. The ball joint assembly of claim 1, wherein an interior of the retainer is spaced from the stud defining an annular volume for retaining a lubricating fluid.

8. The ball joint assembly of claim 7, wherein the ball joint assembly further comprises:
a retainer assembly comprising:
the retainer defining a bond surface, and
a flexible seal overmolded to the retainer along the bond surface and coupled to the at least one stud,
wherein the retainer and flexible seal define, in part, the annular volume.

9. The ball joint assembly of claim 1, wherein the retainer prevents movement of the race relative to the housing.

10. The ball joint assembly of claim 1, wherein the ball joint assembly further comprises:
a second retainer positioned at least partially in the chamber and opposite the ball from the retainer, and
wherein the second retainer engages a second surface of the race.

11. The ball joint assembly of claim 1, wherein:
the housing defines a swaged portion at an opening to the chamber,
wherein the swaged portion limits axial movement of the at least one of the race, the movable shaft, or the retainer relative to the housing.

12. A ball joint assembly comprising:
a housing defining an opening;
a race positioned in the opening and defining:
an annular wall including a seat recess,
a movable shaft including a ball and a first stud extending from the ball, the ball being received in the seat recess and the at least one stud extending out of the chamber; and
a retainer assembly comprising:
a retainer defining a bond surface and positioned at least partially in the chamber, and
a flexible seal overmolded to the retainer along the bond surface and coupled to the at least one stud.

13. The ball joint assembly of claim 12, wherein the flexible seal at least partially defines a grease reservoir annularly about at least the first stud.

14. The ball joint assembly of claim 12, the flexible seal defines an annular projection positioned along the bond surface.

15. The ball joint assembly of claim 12, wherein:
the flexible seal includes a first annular projection and a second annular projection, and
the first annular projection and the second annular projection are axially spaced.

16. The ball joint assembly of claim 12, wherein:
the flexible seal defines a first annular projection and a second annular projection, and
the first annular projection and the second annular projection are radially spaced.

17. The ball joint assembly of claim 12, wherein:
the movable shaft defines a trough positioned between a first flange and a second flange;
the flexible seal is coupled to the movable shaft and positioned at the trough.

18. The ball joint assembly of claim 12, wherein:
an interior surface of the seal defines at least one recess,
the interior surface is engaged with the movable shaft, and
the at least one recess retains grease between the seal and the movable shaft.

19. The ball joint assembly of claim 12, wherein at least one protrusion on one of the race or the retainer engages a corresponding at least one key recess on the other of the race or the retainer to restrict relative movement between the race and the retainer.

20. The ball joint assembly of claim 19, wherein
the at least one protrusion extends from a bottom of the retainer,
the at least one key recess is defined at least in part by a top of the race, and
the bottom of the retainer is contact with the top of the race.
